(19) United States
(12) Patent Application Publication
(10) Pub. No.: US 2024/0322895 A1
(43) Pub. Date: Sep. 26, 2024

(54) POLARIZATION SYNTHESIS FOR WIRELESS COMMUNICATION SYSTEMS

(71) Applicant: ZTE Corporation, Shenzhen (CN)

(72) Inventors: Wei CAO, Shenzhen (CN); Nan ZHANG, Shenzhen (CN); Linxi HU, Shenzhen (CN); Fangyu CUI, Shenzhen (CN)

(73) Assignee: ZTE Corporation, Shenzhen (CN)

(21) Appl. No.: 18/732,226

(22) Filed: Jun. 3, 2024

Related U.S. Application Data
(63) Continuation of application No. PCT/CN2022/082469, filed on Mar. 23, 2022.

(51) Int. Cl. H04B 7/10; H04B 7/185; H04W 74/0833

(52) U.S. Cl. CPC H04B 7/10; H04B 7/18539; H04W 74/0833

(57) ABSTRACT

The present disclosure is directed to synthesizing polarization in wireless communication systems, including determining, by a wireless communication device, at least one virtual antenna port using a plurality of physical antenna ports and communicating, by the wireless communication device with a base station, data using the at least one virtual antenna port.

### CROSS-REFERENCE TO RELATED APPLICATION

This application claims the benefit of priority under 35 U.S.C. § 120 as a continuation of PCT Patent Application No. PCT/CN2022/082469, filed on Mar. 23, 2022, the disclosure of which is incorporated herein by reference in its entirety.

### TECHNICAL FIELD

The disclosure relates generally to wireless communications and, more particularly, to systems, methods, and non-transitory computer-readable media for synthesizing polarization in wireless communication systems.

### BACKGROUND

With the development of New Radio (NR) access technologies (e.g., 5th Generation (5G) wireless communication systems), a broad range of use cases including enhanced mobile broadband, massive Machine-Type Communications (MTC), critical MTC, etc., can be realized. To expand the utilization of NR access technologies, 5G connectivity via satellites and/or airborne vehicles is being considered as a promising application. A network incorporating satellites and/or airborne vehicles to perform the functions (either full or partial) of terrestrial base stations is referred to as a Non-Terrestrial Network (NTN).

### SUMMARY

The example arrangements relate to synthesizing polarization in wireless communication systems, including determining, by a wireless communication device, at least one virtual antenna port using a plurality of physical antenna ports and communicating, by the wireless communication device with a base station, data using the at least one virtual antenna port.

In some arrangements, a base station sends to a wireless communication device, a polarization matrix subset according to polarization capabilities of the wireless communication device, the polarization matrix subset comprises at least one polarization type. The wireless communication device determines at least one virtual antenna port using a plurality of physical antenna ports of the wireless communication device based on the at least one polarization type. The base station communicates with the wireless communication device data using the at least one virtual antenna port.

The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication network, and/or system, in which techniques disclosed herein may be implemented, in accordance with some arrangements.

FIG. 2 illustrates a block diagram of an example wireless communication system for transmitting and receiving wireless communication signals in accordance with some arrangements.

FIG. 3A is a diagram illustrating frequency reuse for beams of a base station, according to various arrangements.

FIG. 3B is a diagram illustrating frequency and polarization reuse for beams of a base station, according to various arrangements.

FIG. 4 is a diagram illustrating antenna array, according to various arrangements.

FIG. 5 is a signaling diagram illustrating codebook-based uplink transmission according to various arrangements.

FIG. 6 illustrates a polarization codebook, according to various arrangements.

FIG. 7 is a table illustrating example of polarization matrix subsets and corresponding polarization type ranges, according to various arrangements.

FIG. 8 is a table illustrating polarization matrices, according to various arrangements.

FIG. 9 is a table illustrating polarization matrices, according to various arrangements.

FIG. 10 is a table illustrating a precoding matrix, according to various arrangements.

FIG. 11 is a diagram illustrating an example method for synthesizing at least one virtual antenna port and communicating using the virtual antenna port, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

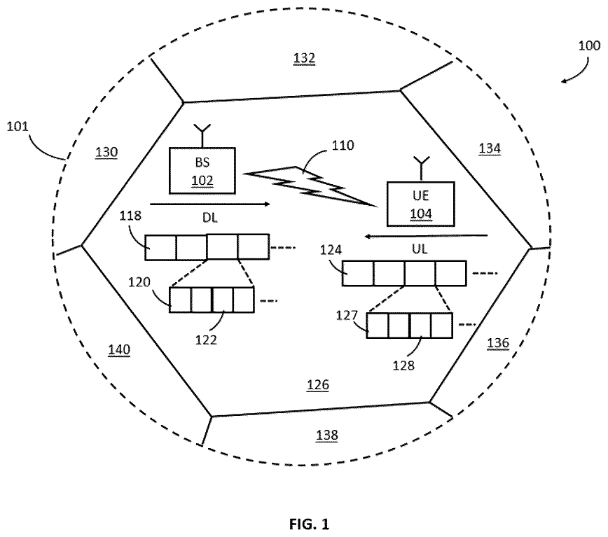

FIG. 1 illustrates an example wireless communication network, and/or system, 100 in which techniques disclosed herein may be implemented, in accordance with an arrangement of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (also referred to as wireless communication node) and a UE device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the base station 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the base station 102 and UE 104 are described herein as non-limiting examples of “communication nodes,” generally, which can practice the methods disclosed herein. Such communication nodes may be capable of wireless and/or wired communications, in accordance with various arrangements of the present solution.

FIG. 2 illustrates a block diagram of an example wireless communication system 200 for transmitting and receiving wireless communication signals (e.g., OFDM/OFDMA signals) in accordance with some arrangements of the present disclosure. The system 200 may include components and elements configured to support known or conventional operating features that need not be described in detail herein. In one illustrative arrangement, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some arrangements, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an evolved node B (eNB), gNB, a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

A NTN with a sufficient number of satellites can provide a global coverage, which is achieved by movable Low Earth Orbit (LEO) and Medium Earth Orbit (MEO) satellites or fixed Geostationary Orbit (GEO) satellites. In some implementations, the coverage of a single satellite is generally implemented by multiple beams. Similar to typical terrestrial networks, resource reuse among different beams can be adopted to improve resource usage efficiency.

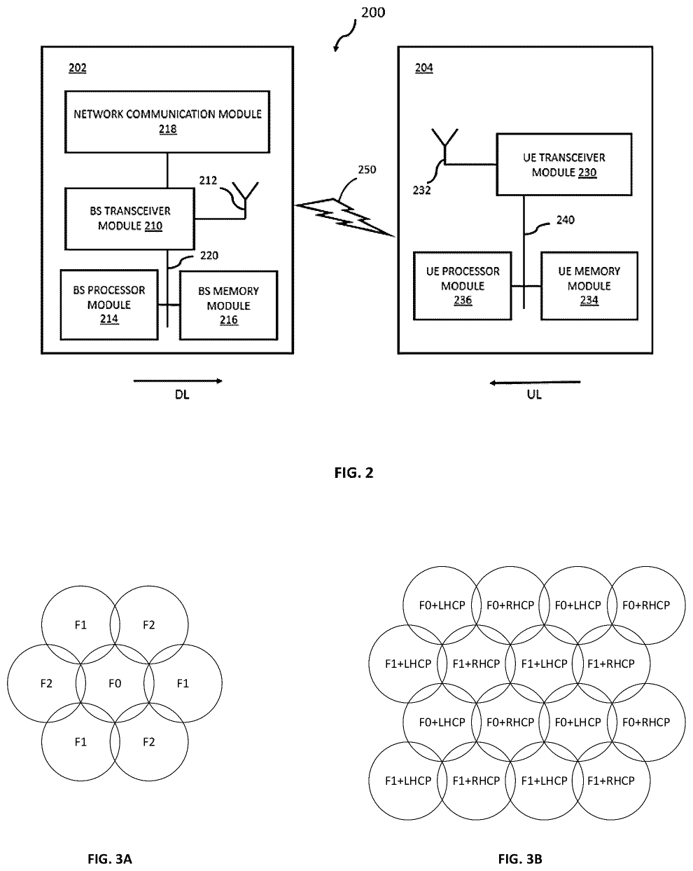

Examples of frequency reuse are illustrated in FIGS. 3A and 3B. FIG. 3A is a diagram illustrating frequency reuse for beams of a base station, according to various arrangements. FIG. 3B is a diagram illustrating frequency and polarization reuse for beams of a base station, according to various arrangements. Each circle in FIGS. 3A and 3B corresponds to a coverage area of a beam of a base station (e.g., base stations 102 and 202). The text within each circle denotes a frequency resource used by the beam represented by that circle.

As shown in FIG. 3A, in some examples, three different frequency resources (e.g., frequency ranges, Bandwidth Parts (BWPs), and so on) denoted as F1, F2, and F3 can be reused among the beams of the base station such that the coverage area of beams with the same frequency resource do not overlap with or are adjacent to one another.

As shown in FIG. 3B, in some examples, frequency and polarization can be reused among the beams of the base station such that the coverage areas of breams with the same frequency resource and the same polarization do not overlap with or are adjunct to one another. As shown, frequency resources F0 and F1 in combination with polarizations such as circular polarization (e.g., Left-Hand Circular Polarization (LHCP) and Right-Hand Circular Polarization (RHCP)). According, the system shown in FIG. 3B requires less frequency resources than the system shown in FIG. 3A.

From the network perspective (e.g., the viewpoint of NTN operators), to serve UEs with different polarization capabilities for global coverage, polarization for multiplexing and polarization for resource reuse need to be implemented. Polarization for multiplexing refers to polarization that can be dynamically scheduled for UEs in a given beam, for example, as shown in FIG. 3A. The polarization for multiplexing can be used in both downlink and uplink. Inter-UE and intra-UE polarization multiplexing can also be implemented. Polarization for resource reuse refers to polarization that is deployed for each beam in a fixed manner, for example, as shown in FIG. 3B. The UEs in a given beam uses the corresponding polarization to ensure best performance.

From the UE perspective (e.g., viewpoint of UEs), a UE may have different polarization capabilities, including LHCP, RHCP, linear polarization, cross linear polarization, and LHCP/RHCP synthesized by two linear polarization.

A legacy-satellite-network UE typically has a Very-Small-Aperture Terminal (VSAT) antenna with circular polarization. A typical Terrestrial Network (TN) handheld UE uses linear polarization. In some examples, a TN handheld UE can support circular polarization with two orthogonal linear antenna elements. Supporting existing handheld UEs with two orthogonal linear antenna elements by the NTN satellite systems using circular polarization, the global coverage of the NTN systems can be available to a large amount of existing cellular handheld UEs.

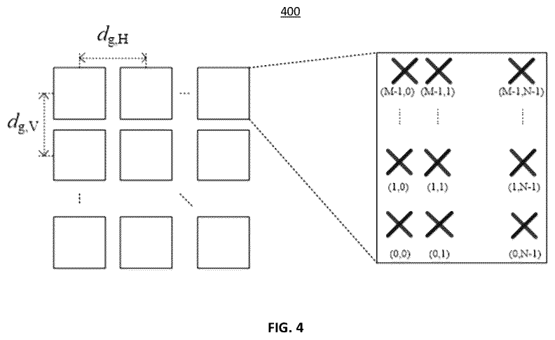

In some examples, the BS antenna is modelled by a uniform rectangular panel array, including M_{g}N_{g} panels, as shown in FIG. 4. FIG. 4 is a diagram illustrating antenna array 400 according to various arrangements. Each box denotes a panel. M_{g} is the number of panels in a column and N_{g} being the number of panels in a row. In some examples as shown in FIG. 4, antenna panels are uniformly spaced with a spacing of d_{g,H} in the horizontal direction and with a spacing of d_{g,V} in the vertical direction. Antenna elements denoted as “X” are placed in each antenna panel in the vertical and horizontal direction. N is the number of columns in the antenna elements, M is the number of antenna elements in the antenna elements. The same polarization is in each column of antenna elements. In some examples, The antenna elements are uniformly spaced in the horizontal direction with a spacing of d_{H} and in the vertical direction with a spacing of d_{V}. The antenna panel is either single polarized (P=1) or dual polarized (P=2). In some examples, a rectangular panel array antenna can be described by the following tuple (M_{g}, N_{g}, M, N, P).

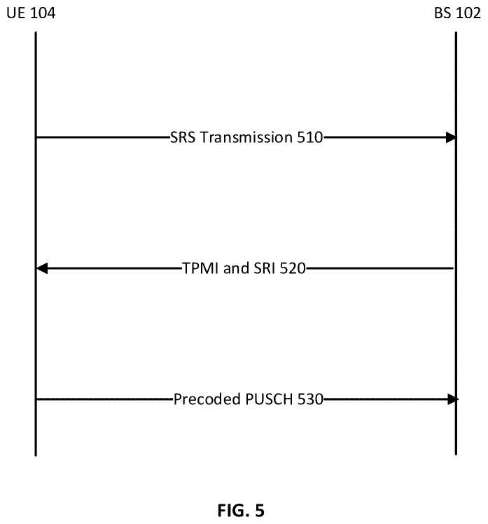

FIG. 5 is a signaling diagram 500 illustrating codebook-based uplink transmission according to various arrangements. At 510, the UE 104 transmits SRS to its serving BS 102. The SRS used for uplink conditions, precoding, etc. The BS 102 determines the SRI and TPMI, and send the same to the UE 104 in an UL grant to the UE. At 530, the UE 104 transmits its precoded PUSCH using the parameters indicated by the BS 102.

In an NTN system, UEs may have different polarization capabilities and antenna types as described herein. In some examples, a UE can support both linear and circular polarizations. The polarization can be switched using advanced antenna system, whereas such switching is hardware-based. For example, some UEs use VSAT antenna, which can support circular/linear polarization switching by the Radio Frequency (RF) controller coupled to the VSAT antenna. This is typically an expensive implementation due to hardware requirement. Alternatively, a UE can switch polarization using advanced signal processing, whereas such switching is software-based. For example, a UE has an antenna array with multiple antenna elements/ports/panels, which can support circular/linear polarization switching by the phase shifting.

In some arrangements, a UE may support only linear polarization or only circular polarization. Some low-cost UEs use single antenna with only linear polarization. For example, an Internet-of-Things (IoT) device in a legacy TN may use such antenna. Some legacy satellite UEs use directional antenna, which supports only RHCP and LHCP, and no other polarization.

The arrangements disclosed herein enables software-based polarization synthesis for existing NR handheld UEs without extra hardware upgrade requirement. In some examples, an NR handheld UE has at least 2 antenna ports for transmission and at least 2 antenna ports for reception for its hardware capabilities. Therefore, such a UE can support both linear and circular polarization with corresponding advanced signaling processing for the multiple antenna ports.

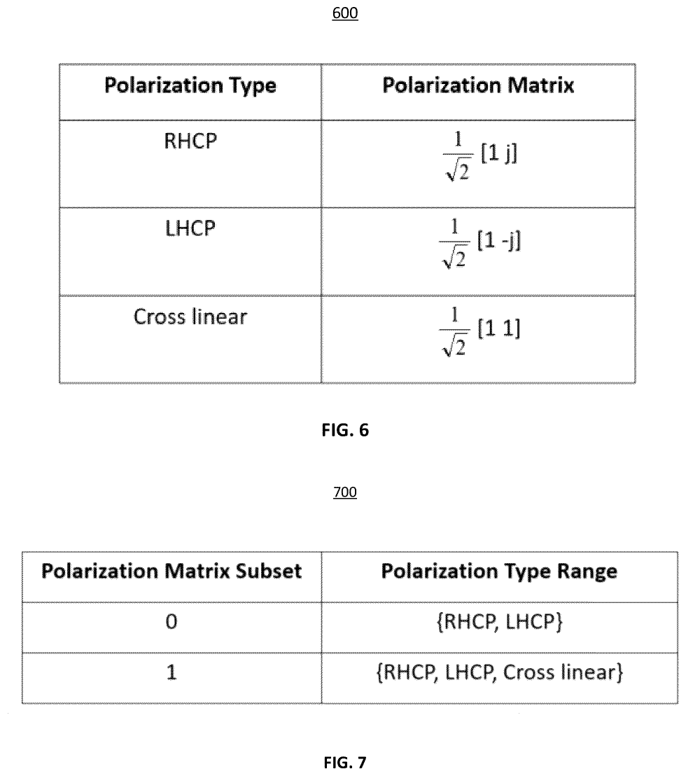

In some implementations, to support different polarization types synthesized by multiple (e.g., two) antenna ports with orthogonal linear polarization, a polarization codebook can be used. The codebook indicates or identifies at least one polarization matrix used to synthesize polarization. In an example involving two antenna ports with orthogonal linear polarization, a circular or cross polarization can be synthesized using a polarization codebook 600 shown in FIG. 6.

In some arrangements, the physical meaning of the polarization matrix can be defined through an example in which the first antenna port has a vertical linear polarization, and the second antenna port has horizontal linear polarization. The first parameter X in the polarization matrix having a form [X, Y] is applied to a first physical antenna port, and the second parameter Y in the polarization matrix is applied to a second physical antenna port. For example, for RHCP, 1 is applied to a first physical antenna port, and j is applied to a second physical antenna port. For RHCP, 1 is applied to a first physical antenna port, and −j is applied to a second physical antenna port. For cross linear polarization, 1 is applied to a first physical antenna port, and 1 is applied to a second physical antenna port.

Taking the first entry in the polarization codebook 600 as an example, the physical meaning of the correspondence between RHCP and [1 j] is given below. The two antenna ports have respective electric field vectors, referred to as Eₓ and E_{y}. That is, a first antenna port has an electric field vector Eₓ while a second antenna port has an electric field vector E_{y}. The phase difference between the two electric field vectors is 90 degrees, which corresponds to the polarization matrix [1 j]. Then, the synthesized electric field has a RHCP. More specifically, in the expressions (1) and (2) below, Eₓ and E_{y} are the two electric field vectors for the two antenna ports.

$${E}_{y} = {\hat{a}}_{y} E sin ω t ; and \qquad ( 1 )$$

$${E}_{x} = {\hat{a}}_{x} E cos ω t . \qquad ( 2 )$$

The parameter âₓ is the unit electric field vector in the horizontal direction. The parameter and â_{y} is the unit electric field vector in the vertical direction. E is the amplitude of each of the two electric field vectors. The synthesized signal resulting from these two antenna ports has a RHCP. In some examples, these two antenna ports can be referred to as virtual antenna ports.

In some examples, the UE can apply a polarization codebook (e.g., the polarization codebook 600) to each virtual antenna port as long as the UE has sufficient number of antenna ports. In an example in which the UE has four antenna ports with indices 0-3, two virtual antenna ports can be determined by synthesizing two circular polarizations (which can be the same or different circular polarizations) with an antenna port group with antenna port indices (0, 1) and an antenna port group with antenna port indices (2, 3). For example, the antenna port group with antenna port indices (0, 1) can be synthesized to a virtual antenna port having a first synthesized circular polarization, and the antenna port group with antenna port indices (2, 3) can be synthesized to a virtual antenna port having a second synthesized circular polarization. The first synthesized circular polarization and the second synthesized circular polarization can be the same in some implementations and different in other implementations.

In some arrangements, polarization matrix subset can be configured by the base station based on a UE's polarization capabilities. In some examples, the base station configures or indicates (e.g., via Radio Resource Control (RRC) signaling) a polarization matrix subset to the UE according to polarization capabilities of the UE. FIG. 7 is a table 700 illustrating example of polarization matrix subsets and corresponding polarization type ranges, according to various arrangements. As shown, a polarization matrix subset with the index 0 corresponds to the polarization type range of RHCP and LHCP. A polarization matrix subset with the index 1 corresponds to the polarization type range of RHCP, LHCP, and cross linear. In the example in which the polarization matrix set is presented in the RRC configuration, the bitwidth for indicating the polarization matrix subset is 1.

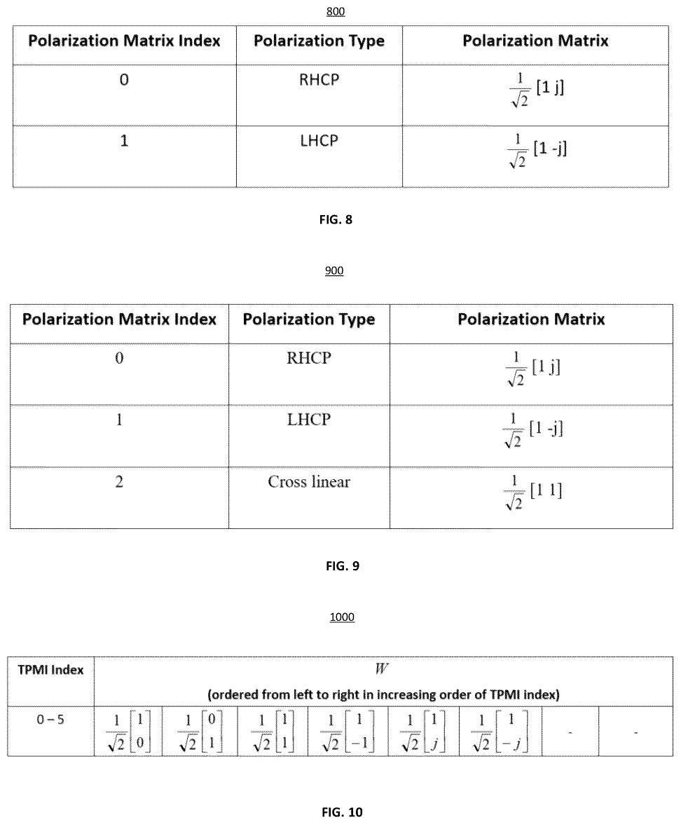

The polarization matrix subset with the index 0 is configured for a UE that supports only circular polarization. In other words, the UE can report its polarization capabilities of supporting only circular polarization to the base station, the base station can configure polarization matrix subset with the index 0. The corresponding polarization matrix indices are shown in the table 800 in FIG. 8. As shown in FIG. 8, the polarization matrix index of 0 corresponds to polarization type RHCP, which has the polarization matrix as shown. The polarization matrix index of 1 corresponds to polarization type LHCP, which has the polarization matrix as shown.

The polarization matrix subset with the index 1 is configured for a UE that supports both linear and circular polarizations. In other words, the UE can report its polarization capabilities of supporting both linear and circular polarizations to the base station, the base station can configure polarization matrix subset with the index 1. The corresponding polarization matrix indices are shown in the table 900 in FIG. 9. As shown in FIG. 9, the polarization matrix index of 0 corresponds to polarization type RHCP, which has the polarization matrix as shown. The polarization matrix index of 1 corresponds to polarization type LHCP, which has the polarization matrix as shown. The polarization matrix index of 2 corresponds to polarization type cross linear, which has the polarization matrix as shown.

In some arrangements, polarization synthesis for uplink physical channels involve physical channels and reference signals include Physical Uplink Shared Channel (PUSCH), Physical Uplink Control Channel (PUCCH), Sounding Reference Signal (SRS), Physical Random Access Channel (PRACH), and so on.

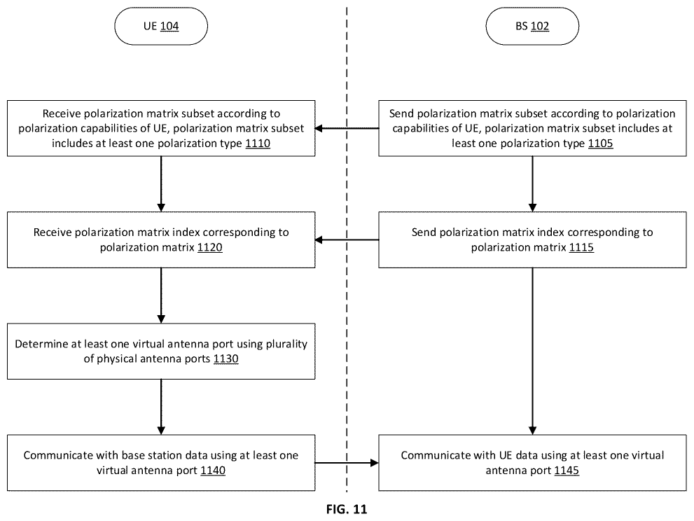

In some implementations, multiple physical antenna ports can be used for PUSCH transmission. For example, for a single-layer transmission using two physical antenna ports, following Transmit Precoding Matrix Index (TPMI), a precoding matrix W 1000 as shown in FIG. 10 can be used. The base station indicates to the UE the TPMI index. The UE applies the corresponding precoding matrix to the symbols.

Similarly, in some arrangements, the base station can indicate a polarization matrix index to the UE, if the UE has been configured a polarization matrix subset. In some examples in which the UE is configured with the polarization matrix subset 0, the corresponding polarization matrix as shown in FIG. 8 can applied to the symbols on the two antenna ports to synthesize the corresponding polarization (e.g., RHCP or LHCP).

Though the form of the polarization matrix appears similar to the precoding matrix, they have different physical meaning. In some examples, the precoding matrix is used to coherently combine a same symbol on the two physical antenna ports. The polarization matrix, on the other hand, is used to synthesize circular polarization with a same symbol on the two physical antenna ports with orthogonal linear polarization. In other words, a virtual antenna port with circular polarization is synthesized by the polarization matrix using these two physical antenna ports.

For more than one layer transmission, a virtual antenna port can be synthesized for each layer. The methods by which a virtual antenna port can be synthesized can be applied for virtual antenna port.

In some implementations, PUCCH transmission uses a single physical antenna port. If a virtual antenna port with circular polarization is needed for PUCCH transmission, two physical antenna ports with orthogonal linear polarization are needed. The PUCCH symbols on these two antenna ports are the same. The polarization matrix is applied to synthesize the circular polarization indicated by the polarization matrix.

In some implementations, SRS transmission can use multiple antenna ports. In a same SRS resource, the SRS symbols on different antenna ports are different. For example, the SRS symbols can be Frequency Division Multiplexed (FDMed) (e.g., using different combs) or Code Division Multiplexed (CDMed) (e.g., using different cyclic shifts).

In the example in which a virtual antenna port with circular polarization is used for SRS transmission, two physical antenna ports with orthogonal linear polarization are needed. The SRS symbols on these two physical antenna ports are the same. That is, the SRS symbols on the two physical antenna ports have the same SRS sequence (i.e., the same cyclic shift) and the same time/frequency resource. Specifically, the two physical antenna ports referred to as pᵢ and pᵢ′ use the same cyclic shift a; in SRS sequence generation and the same frequency-domain starting position k₀⁽ⁱ⁾ in physical resource mapping (e.g., CDM or FDM is not used). Then the polarization matrix is applied to the same symbols to synthesize the circular polarization.

In some implementations, PRACH transmission uses a single antenna port. In the example in which a virtual antenna port with circular polarization is needed for PRACH transmission, two physical antenna ports with orthogonal linear polarization are used to synthesize a virtual antenna port. The PRACH preamble on these two physical antenna ports are the same. The UE applies the polarization matrix to synthesize the circular polarization indicated by the polarization matrix.

In some implementations, the polarization used by downlink transmission can be indicated in System Information (SI), especially when polarization is used in the resource reuse scheme. In this case, the downlink polarization is semi-static and applicable to all downlink physical channels. A UE matches its reception polarization with the indicated downlink polarization. In some arrangements, to serve the UEs with at least two physical antenna ports with orthogonal linear polarization, the polarization codebook can be predefined. The UE applies the polarization matrix corresponding to the downlink polarization to the physical antenna ports according to the indicated downlink polarization.

In some arrangements, the polarization used by uplink transmission can be indicated in SI or UE-specific signaling. In the example in which polarization is used in the resource reuse scheme, uplink polarization may be broadcasted to the UEs within a cell in System Information Block (SIB) or may be implicitly indicated by the downlink polarization in the same SIB (e.g., the downlink polarization is the same as the uplink polarization). In this case, the uplink polarization is semi-static and applicable to all uplink physical channels. A UE matches its transmission polarization with the indicated uplink polarization. To serve the UEs with at least two physical antenna ports with orthogonal linear polarization, the polarization codebook can be predefined. The UE applies the corresponding polarization matrix to its physical antenna ports according to the indicated uplink polarization.

In the example in which polarization is used for polarization multiplexing (including inter-UE and intra-UE), uplink polarization is generally indicated via UE-specific signaling, e.g., uplink grant for PUSCH/PUCCH/SRS/PRACH. In this case, the polarization matrix subset can be configured by the base station to the UE via RRC signaling. The polarization indication can be included in the scheduling signaling, e.g., Downlink Control Information (DCI). The bitwidth for the polarization indication in the DCI is determined by the configured polarization matrix subset. If the polarization matrix subset 0 is configured, the bitwidth is 1. If the polarization matrix subset 1 is configured, the bitwidth is 2.

FIG. 11 is a diagram illustrating an example method 1100 for synthesizing at least one virtual antenna port and communicating using the virtual antenna port, according to various arrangements. Referring to FIGS. 1-11, the method 1100 can be performed by the UE 104 and the BS 102.

At 1105, the base station 102 sends to the UE 104 a polarization matrix subset according to polarization capabilities of the UE. The polarization matrix subset includes at least one polarization type (e.g., RHCP, LHCP, cross linear, etc.). Each of the each of the at least one polarization type corresponds to a polarization matrix. The UE 104 receives the polarization matrix subset at 1110.

At 1115, the BS 102 sends to the UE 104 a polarization matrix index corresponding to a polarization matrix. The UE 104 receives the same at 1120.

At 1130, the UE 104 determines at least one virtual antenna port using a plurality of physical antenna ports of the UE 104.

In some examples, the plurality of physical antenna ports includes a first physical antenna port and a second physical antenna port. The first antenna port has a first polarization. The second antenna port has a second polarization. The at least one virtual antenna port includes a first virtual antenna port. The first virtual antenna port has a first synthesized polarization. The first polarization, the second polarization, and the third first synthesized polarization are different. In some examples, the first polarization includes vertical linear polarization. The second polarization comprises horizontal linear polarization. The first synthesized polarization comprises one of a circular polarization or a cross polarization.

In some examples, the plurality of physical antenna ports includes a third physical antenna port and a fourth physical antenna port. The third antenna port has a third polarization. The fourth antenna port has a fourth polarization. The at least one virtual antenna port includes a second virtual antenna port. The first second virtual antenna port has a second synthesized polarization. The third polarization, the fourth polarization, and the second synthesized polarization are different. In some arrangements, the first synthesized polarization and the second synthesized polarization are different.

In some arrangements, determining the at least one virtual antenna port using the plurality of physical antenna ports includes applying, by the UE 104, a polarization codebook to the plurality of physical antenna ports, the polarization codebook includes a polarization matrix corresponding to a polarization type. In some arrangements, applying the polarization codebook obtains at least one of a circular polarization or a cross polarization for the at least one virtual antenna port from orthogonal linear polarization of the plurality of physical antenna ports. In some examples, the polarization codebook can be a codebook such as the polarization codebook 600.

In some examples, the plurality of physical antenna ports includes a first physical antenna port and a second physical antenna port. The at least one virtual antenna port includes a first virtual antenna port. The UE 104 applies the polarization matrix on symbols of the first physical antenna port and the second physical antenna port to synthesize a polarization of the first virtual antenna port. The first physical antenna port and the second physical antenna port have orthogonal linear polarization.

In some examples, the UE 104 applies the polarization matrix on a same symbol of the first physical antenna port and the second physical antenna port to synthesize a polarization of the first virtual antenna port. The UE 104 sends a PUSCH to the base station 102 using the polarization of the first virtual antenna port.

In some examples, the UE 104 applies the polarization matrix on a same symbol of the first physical antenna port and the second physical antenna port to synthesize a polarization of the first virtual antenna port. The UE 104 sends PUCCH to the base station 102 using the polarization of the first virtual antenna port.

In some examples, the UE 104 applies the polarization matrix on a same symbol of the first physical antenna port and the second physical antenna port to synthesize a polarization of the first virtual antenna port. The first physical antenna port and the second physical antenna port have a same cyclic shift and frequency-domain starting position. The UE 104 sends an SRS to the base station 102 using the polarization of the first virtual antenna port.

In some examples, the UE 104 applies the polarization matrix on a same symbol of the first physical antenna port and the second physical antenna port to synthesize a polarization of the first virtual antenna port. The UE 104 sends to the base station 102 PRACH using the polarization of the first virtual antenna port.

In some examples, the UE 104 receives from the base station 102 an indication of downlink polarization. The UE 104 determines the downlink polarization using the polarization matrix. The UE 104 receives from the BS 102 downlink data using the downlink polarization.

In some examples, the UE 104 receives from the base station 102, an indication of uplink polarization. The UE 104 determines the uplink polarization using the polarization matrix. The UEs 104 ends to the base station 102 uplink data using the uplink polarization.

At 1140 and 1145, the UE 104 and the base station 102 communicate data with each other using the at least one virtual antenna port.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

1. A wireless communication method, comprising:
determining, by a wireless communication device, at least one virtual antenna port using a plurality of physical antenna ports; and
communicating, by the wireless communication device with a base station, data using the at least one virtual antenna port.

2. The wireless communication method of claim 1, wherein
the plurality of physical antenna ports comprises a first physical antenna port and a second physical antenna port;
the first antenna port has a first polarization;
the second antenna port has a second polarization;
the at least one virtual antenna port comprises a first virtual antenna port;
the first virtual antenna port has a first synthesized polarization; and
the first polarization, the second polarization, and the first synthesized polarization are different.

3. The wireless communication method of claim 2, wherein
the first polarization comprises vertical linear polarization;
the second polarization comprises horizontal linear polarization; and
the first synthesized polarization comprises one of a circular polarization or a cross polarization.

4. The wireless communication method of claim 1, wherein determining the at least one virtual antenna port using the plurality of physical antenna ports comprises applying a polarization codebook to the plurality of physical antenna ports, the polarization codebook comprising a polarization matrix corresponding to a polarization type.

5. The wireless communication method of claim 4, wherein applying the polarization codebook comprises obtaining at least one of a circular polarization or a cross polarization for the at least one virtual antenna port from orthogonal linear polarization of the plurality of physical antenna ports.

6. The wireless communication method of claim 4, wherein the polarization codebook comprises:

| Polarization Type | Polarization Matrix |
|---|---|
| RHCP | $\frac{1}{\sqrt{2}} [ 1 j ]$ |
| LHCP | $\frac{1}{\sqrt{2}} [ 1 - j ]$ |
| Cross linear | $\frac{1}{\sqrt{2}} [ 11 ]$ |

7. The wireless communication method of claim 1, further comprising receiving, by the wireless communication device from the base station, a polarization matrix subset according to polarization capabilities of the wireless communication device, the polarization matrix subset comprises at least one polarization type.

8. The wireless communication method of claim 7, wherein
each of the at least one polarization type corresponds to a polarization matrix; and
the wireless communication method further comprising receiving, by the wireless communication device from the base station, a polarization matrix index corresponding to a polarization matrix.

9. The wireless communication method of claim 8, wherein
the plurality of physical antenna ports comprises a first physical antenna port and a second physical antenna port;
the at least one virtual antenna port comprises a first virtual antenna port;
the wireless communication method further comprises applying the polarization matrix on symbols of the first physical antenna port and the second physical antenna port to synthesize a polarization of the first virtual antenna port; and
the first physical antenna port and the second physical antenna port have orthogonal linear polarization.

10. The wireless communication method of claim 9, further comprises:
applying the polarization matrix on a same symbol of the first physical antenna port and the second physical antenna port to synthesize a polarization of the first virtual antenna port; and
sending Physical Uplink Shared Channel (PUSCH) using the polarization of the first virtual antenna port.

11. The wireless communication method of claim 9, further comprises:
applying the polarization matrix on a same symbol of the first physical antenna port and the second physical antenna port to synthesize a polarization of the first virtual antenna port; and
sending Physical Uplink Control Channel (PUCCH) using the polarization of the first virtual antenna port.

12. The wireless communication method of claim 9, further comprises:
applying the polarization matrix on a same symbol of the first physical antenna port and the second physical antenna port to synthesize a polarization of the first virtual antenna port,
wherein the first physical antenna port and the second physical antenna port have a same cyclic shift and frequency-domain starting position; and
sending Sounding Reference Signal (SRS) using the polarization of the first virtual antenna port.

13. The wireless communication method of claim 9, further comprises:
applying the polarization matrix on a same symbol of the first physical antenna port and the second physical antenna port to synthesize a polarization of the first virtual antenna port; and
sending Physical Random Access Channel (PRACH) using the polarization of the first virtual antenna port.

14. The wireless communication method of claim 8, further comprising:
receiving, by the wireless communication device from the base station, an indication of downlink polarization;
determining, by the wireless communication device, the downlink polarization using the polarization matrix; and
receiving, by the wireless communication device from the base station, downlink data using the downlink polarization.

15. The wireless communication method of claim 8, further comprising:
receiving, by the wireless communication device from the base station, an indication of uplink polarization;
determining, by the wireless communication device, the uplink polarization using the polarization matrix; and
sending, by the wireless communication device to the base station, uplink data using the uplink polarization.

16. A wireless communication method, comprising:
receiving, by a base station from the wireless communication device with a base station, data using at least one virtual antenna port,
wherein the at least one virtual antenna port is determined using a plurality of physical antenna ports.

17. A base station, comprising:
at least one processor configured to:
receive, via a receiver from the wireless communication device with a base station, data using at least one virtual antenna port,
wherein the at least one virtual antenna port is determined using a plurality of physical antenna ports.

18. A wireless communication device, comprising:
at least one processor configured to:
determine at least one virtual antenna port using a plurality of physical antenna ports; and
communicate, via a transceiver with a base station, data using the at least one virtual antenna port.

19. The wireless communication device of claim 18, wherein
the plurality of physical antenna ports comprises a first physical antenna port and a second physical antenna port;
the first antenna port has a first polarization;
the second antenna port has a second polarization;
the at least one virtual antenna port comprises a first virtual antenna port;
the first virtual antenna port has a first synthesized polarization; and
the first polarization, the second polarization, and the first synthesized polarization are different.

20. The wireless communication device of claim 19, wherein
the first polarization comprises vertical linear polarization;
the second polarization comprises horizontal linear polarization; and
the first synthesized polarization comprises one of a circular polarization or a cross polarization.
